(19) United States
(12) Patent Application Publication
(10) Pub. No.: US 2020/0251860 A1
(43) Pub. Date: Aug. 6, 2020

(54) PLUG LIGHT

(71) Applicant: Teresa Deshawn Baker, Flint, MI (US)

(72) Inventor: Teresa Deshawn Baker, Flint, MI (US)

(21) Appl. No.: 16/263,156

(22) Filed: Jan. 31, 2019

(51) Int. Cl. H01R 13/717; H01R 13/70; H01R 13/46; H01R 31/06

(52) U.S. Cl. CPC H01R 13/7175; H01R 13/70; F21Y 2115/10; H01R 31/06; H01R 13/465

(57) ABSTRACT

A plug light includes a clip having a channel. The channel defines a semi-circular cylinder shape and includes a gap defined between opposing edges of the clip forming an entrance into the channel. The channel is sized to releasably receive a power cord or any type of cable within. A light emitter is coupled to the clip. A power source provides power to the light emitter.

### BACKGROUND OF THE INVENTION

The present invention relates to finding outlets in the dark and, more particularly, to a plug light for finding outlets in low light.

Power sockets tend to be located near the ground. If a room has low light, the socket may be difficult to see. In such cases, it may be difficult for individuals with diminished eye sight to place the plug within the socket. Additionally, ports of a television or other type of electronic device may be difficult to see.

As can be seen, there is a need for a plug light to help individuals clearly see power sockets and ports of electronic devices.

### SUMMARY OF THE INVENTION

In one aspect of the present invention, a plug light comprises: a clip comprising an channel defining a semi-circular cylinder shape and comprising a gap defined between opposing edges of the clip forming an entrance into the channel, wherein the channel is sized to releasably receive a power cord within; a light emitter coupled to the clip; and a power source providing power to the light emitter.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a bottom perspective exploded view of an embodiment of the present invention;

FIG. 3 is a section view of the present invention, taken along line 10-10 in FIG. 1; and

FIG. 4 is a top rear perspective view of an embodiment of the present invention shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

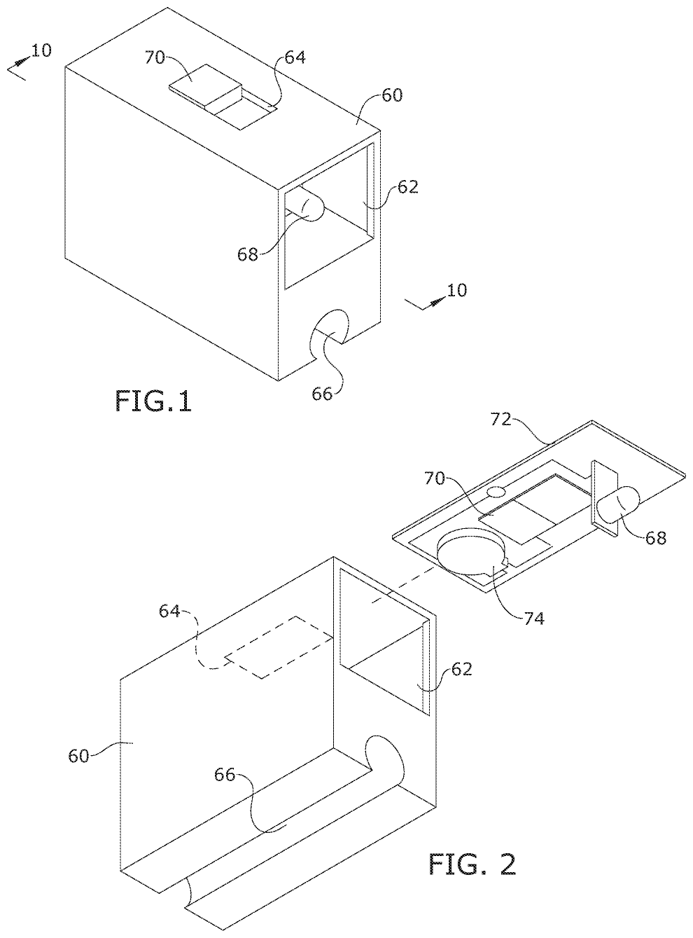

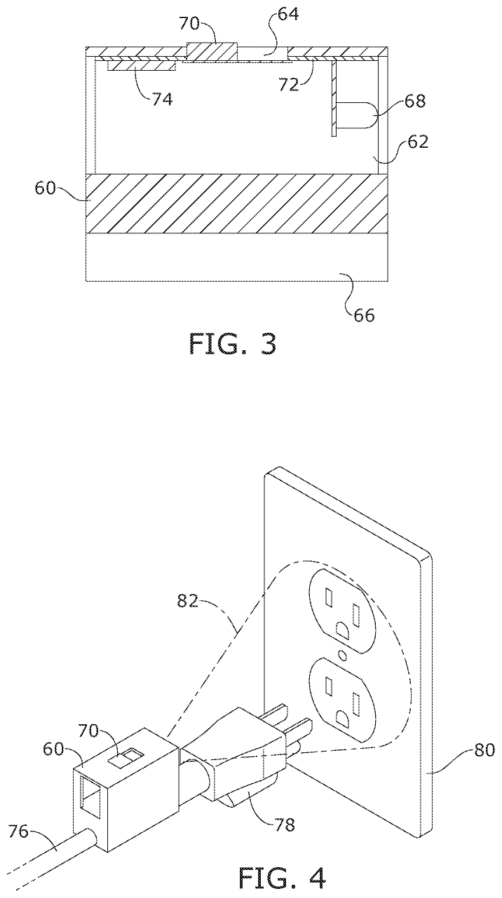

Referring to FIGS. 1 through 4, the present invention may further includes a plug light. The plug light includes a clip 66 having a channel. The channel defines a semi-circular cylinder shape and includes a gap defined between opposing edges of the clip forming an entrance into the channel. The channel is sized to releasably receive a power cord 76 within. A light emitter 68 is coupled to the clip 66. A power source 74 provides power to the light emitter 68.

The present invention may further includes a housing 60 having a top wall, a bottom wall, a front wall, a rear wall, a first side wall, and a second side wall. The clip 66 is part of the bottom wall such than the channel extends along the entire length of the bottom wall and ends at an opening defined on the front wall and an opening defined on the rear wall.

The light emitter 68 may be coupled to the housing so that light 82 is emitted from the front wall. For example, the front wall may include an opening 62. The light emitter 68 is coupled within the housing 60 and is disposed within the opening 62 so that the light 82 is emitted from the front wall. The light emitter 68 may be a light emitting diode or other type of light bulb.

The present invention includes a circuit board 72. A switch 70, the power supply 74, and the light emitter 68 are electrically connected by the circuit board 72. The power supply 74 may include a battery releasably coupled within a battery compartment of the housing 70. The switch 70 may be coupled to the housing 60 within a switch slot 64 defined on the top wall. The switch 70 is used to turn on and off the light emitter 68, electrically connecting the power supply 74 with the light emitter 68 and electrically disconnecting the power supply 74 from the light emitter 68.

In use, a power cord 76 is pushed through the entrance and into the channel of the clip 66. The light emitter 68 emits light 82 in front of the plug 78 so that the user may clearly see an outlet 80 in a low light situation. Additionally, the clip 66 may releasably attach to other types of cables, such as connection cables to view ports on a back or side of a television or other electronic device.

It should be understood, of course, that the foregoing relates to exemplary embodiments of the invention and that modifications may be made without departing from the spirit and scope of the invention as set forth in the following claims.

1. A plug light comprising: A channel comprising a channel defining a semi-circular cylinder shape and comprising a opening defined between oposing edged of the channel forming an entrance into the channel, wherein the channel is sized to releasably receive a power cord within; a light emitter linked to the channel; and a power source providing power to the light emitter.

2. The plug light of claim 1, further comprising a button operatively connected to the light.

3. The plug light of claim 1, further comprising a casing comprising a top panel, a bottom panel, a front panel , a rear panel, a first side panel, and a second side panel; wherein the channel is part of the bottom panel and the light emitter is linked to the casing so that the light is emitted from the front panel.

4. The plug light of claim 3, wherein the front panel comprises an opening, wherein the light emitter emits light through the opening.

5. (canceled)

6. The plug light of claim 1, wherein the power source is a battery releasably linked within a battery compartment of the casing.

7. The plug light comprises panels within the channel is part of the bottom panel.
